(19) United States
(12) Patent Application Publication
(10) Pub. No.: US 2011/0090038 A1
(43) Pub. Date: Apr. 21, 2011

(54) TRANSFORMER HAVING INTERLEAVED WINDINGS AND METHOD OF MANUFACTURE OF SAME

(75) Inventor: David Perchlik, Redmond, WA (US)

(73) Assignee: INTERPOINT CORPORATION, Redmond, WA (US)

(21) Appl. No.: 12/580,548

(22) Filed: Oct. 16, 2009

(51) Int. Cl. H01F 27/28; H01F 41/00

(52) U.S. Cl. 336/223; 29/605

(57) ABSTRACT

A transformer may include a first and a second continuous single piece multi-turn helical winding where at least some turns of the windings are interleaved. The turns of the windings are electrically insulated from one another and spaced sufficiently close together to permit inductive coupling therebetween. The single piece multi-turn helical windings may have a continuous or smooth radius of curvature, with no discontinuities or singularities between first and second end terminals. The transformer may be formed by wrapping first and second electrical conductors about a winding form to form the first and second continuous single piece multi-turn helical windings substantially concurrently. Alternatively, a second continuous single piece multi-turn helical winding may be advanced on a first continuous single piece multi-turn helical winding, for example by rotation with respect thereto.

### BACKGROUND

1. Field

This disclosure generally relates to transformers having primary and secondary windings.

2. Description of the Related Art

Transformers are useful for stepping up or stepping down a voltage and/or for electrically isolating two portions of a circuit.

A transformer typically includes at least two windings of electrically conductive material such as wire. The windings are electrically isolated from one another but spaced sufficient close together such that an electrical current flow through one winding will induce an electrical current to flow in the other winding. The winding through which the current is driven is typically denominated as the primary winding, while the winding in which the current is induced is typically denominated as the secondary winding. The transformer may also include a core, for example a magnetic or ferrous core extending between the windings.

A large variety of transformers of various designs are currently commercially available. Numerous transformers of other designs have been available in the past. Numerous other transformer designs have been proposed.

In many applications, transformer size and/or weight are important factors in realizing a practical and/or commercially successful device. For example, transformers for use in avionics typically must be lightweight and may need to occupy a small volume. Such applications, however, typically require high performance. Performance may be dictated by a number of factors; for example, the amount of conductive material in the windings, the surface area of the windings, and/or the proximity of the windings to one another. Many applications may additionally, or alternatively, require low-cost transformers. Cost may be dictated by a number of factors including type of materials, amount of materials, and/or complexity of manufacture, among other factors.

New transformer designs and methods of manufacture of transformers are desirable to address at least some of the disparate needs of various technical applications that employ transformers.

### BRIEF SUMMARY

A transformer may be summarized as including a first continuous single piece multi-turn helical winding having a continuous smooth radius of curvature with no discontinuities between a first terminal and a second terminal as projected on an X-Y plane that is perpendicular to a longitudinal axis of the first continuous single piece multi-turn helical winding; and a second continuous single piece multi-turn helical winding having a continuous radius of curvature with no discontinuities between a first terminal and a second terminal as projected on an X-Y plane that is perpendicular to a longitudinal axis of the second continuous single piece multi-turn helical winding, the second continuous single piece multi-turn helical winding electrically insulated from the first continuous single piece multi-turn helical winding and having at least some of a plurality of successive turns of the second continuous single piece multi-turn helical winding interleaved between respective pairs of at least some of a plurality of successive turns of the first continuous single piece multi-turn helical winding to inductively couple therebetween.

At least one of the first or the second continuous single piece multi-turn helical windings may include a conductor having a rectangular cross-section taken perpendicular to a longitudinal axis of the first or the second continuous single piece multi-turn helical windings at a point along the longitudinal axis. At least one of the first or the second continuous single piece multi-turn helical windings may include an electrical conductor having an electrically insulating sheath thereabout. The second continuous single piece multi-turn helical winding may be co-axially aligned with the first continuous single piece multi-turn helical winding. The second continuous single piece multi-turn helical winding may have an outer diameter that is equal to an outer diameter of the continuous single piece multi-turn helical winding. The second continuous single piece multi-turn helical winding may have an inner diameter that is equal to an inner diameter of the first continuous single piece multi-turn helical winding. At least one of the first or the second continuous single piece multi-turn helical windings may be cylindrical. The first continuous single piece multi-turn helical winding may have only two terminals, each of the two terminals extending from a respective end of the first continuous single piece multi-turn helical winding and wherein the second continuous single piece multi-turn helical winding may have only two terminals, each of the two terminals extending from a respective end of the second continuous single piece multi-turn helical winding. The transformer may further include at least a portion of a ferromagnetic core received within an inner diameter of at least one of the first or the second continuous single piece multi-turn helical windings.

A method of forming a transformer may be summarized as including wrapping a first electrical conductor about a winding form to form a first continuous single piece multi-turn helical winding; and wrapping a second electrical conductor about the winding form to form a second continuous single piece multi-turn helical winding, the second continuous single piece multi-turn helical winding electrically insulated from the first continuous single piece multi-turn helical winding, with at least some of a number of successive turns of the second continuous single piece multi-turn helical winding interleaved between pairs of at least some of a number of successive turns of the first continuous single piece multi-turn helical windings to inductively couple therebetween.

Wrapping the second electrical conductor about the form may be performed substantially concurrently with wrapping the first electrical conductor about the form. Wrapping a first electrical conductor about a winding form may include wrapping the first electrical conductor having a rectangular cross-section about the winding form to produce a smooth radius of curvature between a first terminal and a second terminal of the first multi-turn helical winding. Wrapping at least one of the first or the second electrical conductors about the winding form may include wrapping a sheathed electrical wire about the winding form. The method may further include inserting at least a portion of a ferromagnetic core within an inner diameter formed by the first and the second continuous single piece multi-turn helical windings. Wrapping a second electrical conductor to form a second continuous single piece multi-turn helical winding may include wrapping the second continuous single piece multi-turn winding such that a ratio of turns of the first continuous single piece multi-turn helical winding to turns of the second continuous single piece multi-turn helical winding is not equal to N+1:N, where N represents the number of turns in the second continuous single piece multi-turn winding. The ratio of turns may be greater than N+1:N, less than N+1:N or equal to N+1:N.

A method of forming a transformer may be summarized as including wrapping a first electrical conductor to form a first continuous single piece multi-turn helical winding; wrapping a second electrical conductor to form a second continuous single piece multi-turn helical winding; and advancing the second continuous single piece multi-turn helical winding along a longitudinal axis of the first continuous single piece multi-turn helical winding to position at least some of the turns of the second continuous single piece multi-turn helical winding interleaved between at least some of the turns of the first continuous single piece multi-turn helical winding to inductively couple therebetween.

Advancing the second continuous single piece multi-turn helical winding along a longitudinal axis of the first continuous single piece multi-turn helical winding may include rotating the second continuous single piece multi-turn helical winding about the longitudinal axis with respect to the first continuous single piece multi-turn helical winding. Wrapping a second electrical conductor to form a second continuous single piece multi-turn helical winding may include wrapping the second electrical conductor to form the second continuous single piece multi-turn helical winding to have an outer diameter equal to an outer diameter of the first continuous single piece multi-turn helical winding. Wrapping a second electrical conductor to form a second continuous single piece multi-turn helical winding may include wrapping the second electrical conductor to form the second continuous single piece multi-turn helical winding to have an inner diameter equal to an inner diameter of the first continuous single piece multi-turn helical winding. Wrapping a first electrical conductor to form a first continuous single piece multi-turn helical winding may include wrapping the first electrical conductor having a rectangular cross-section to produce a smooth radius of curvature of the first continuous single piece multi-turn helical winding and wherein wrapping a second electrical conductor to form a second continuous single piece multi-turn helical winding may include wrapping the second electrical conductor having a rectangular cross-section to produce a smooth radius of curvature of the second continuous single piece multi-turn helical winding. Wrapping at least one of the first or the second electrical conductors may include wrapping a sheathed electrical conductor having an electrically insulating sheath thereabout. The method may further include inserting at least a portion of a ferromagnetic core within an inner diameter formed by the first and the second continuous single piece multi-turn helical windings.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a front top isometric view of a transformer having first and second continuous single piece multi-turn helical windings with turns of the windings interleaved, according to one illustrated embodiment.

FIG. 2 is a top rear isometric view of the transformer of FIG. 1.

FIG. 3 is a top plan view of the transformer of FIG. 1.

FIG. 4 is a front elevational view of a transformer according to one illustrated embodiment where there is a single turn of the second continuous single piece multi-turn helical winding between each pair of turns of the first continuous single piece multi-turn helical winding.

FIG. 5 is a front top isometric view of a transformer according to another illustrated embodiment in which a core is received by the first and second continuous single piece multi-turn helical windings.

FIG. 6 is a front top isometric view of a housing including a core element to be received by a transformer having first and second continuous single piece multi-turn helical windings, according to another illustrated embodiment.

FIG. 7 is an isometric view showing first and second continuous single piece multi-turn helical windings being wrapped around a winding form or mandrel to form a number of interleaved turns, according to one illustrated embodiment.

FIG. 7A is a cross-sectional view of one of the multi-turn windings taken along section line 7A of FIG. 7, showing an electrical conductor with a rectangular cross section and an electrically insulative sheath.

FIG. 8 is an isometric view of a second continuous single piece multi-turn helical winding being advanced along a longitudinal axis of a first continuous single piece multi-turn helical winding such that the turns of the windings will be interleaved, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with transformers, circuits employing transformers, and machinery useful in manufacturing transformers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

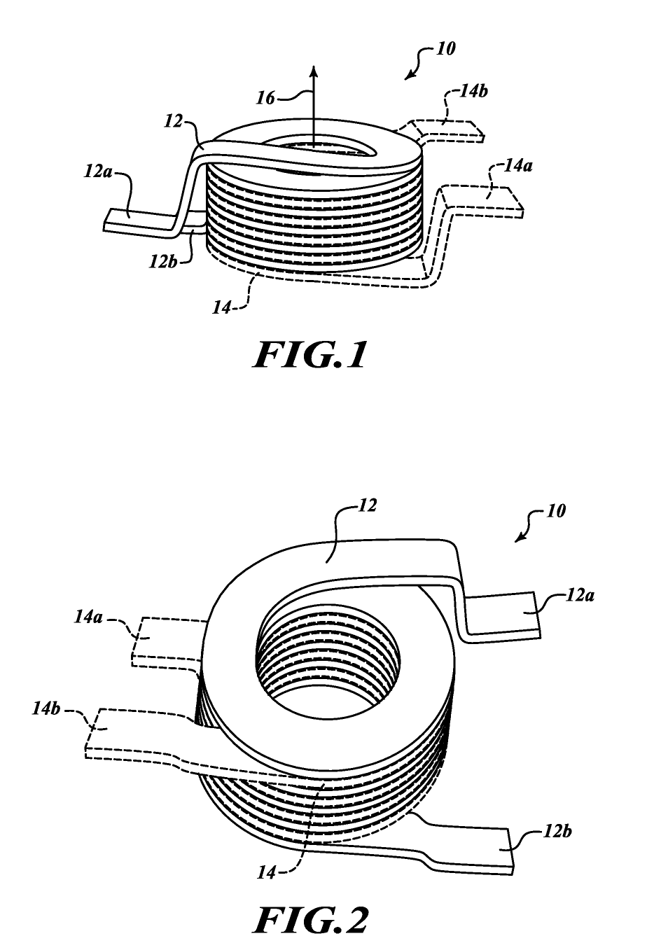

FIGS. 1-3 show a transformer 10 according to one illustrated embodiment.

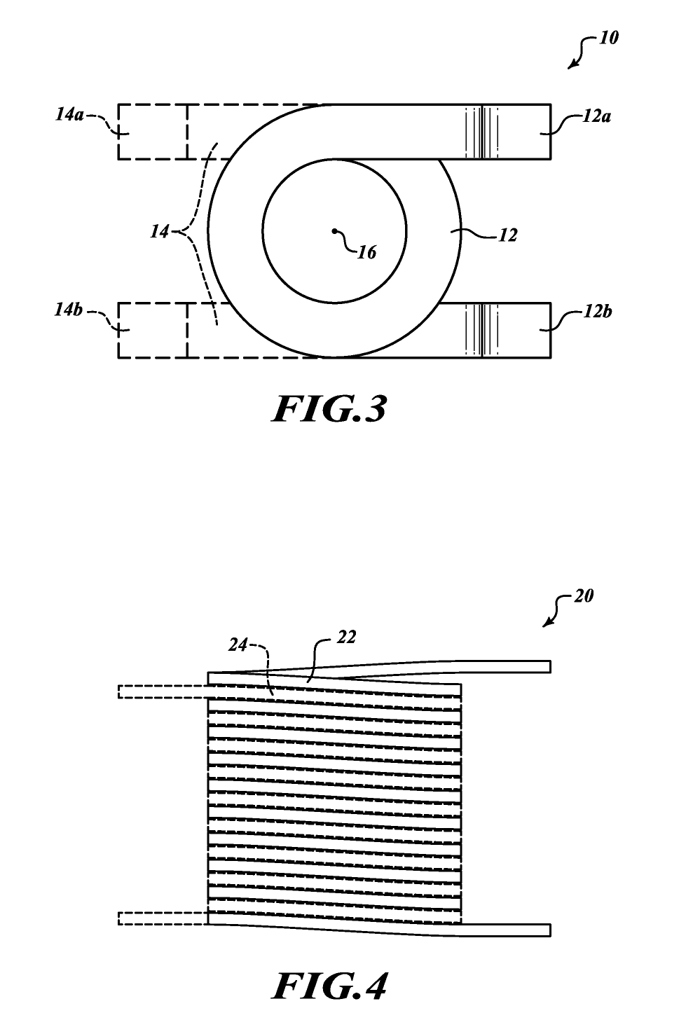

The transformer 10 includes a first continuous single piece multi-turn electrical winding 12 and a second continuous single piece multi-turn helical winding 14. The second continuous single piece multi-turn helical winding 14 is electrically insulated from the first continuous single piece multi-turn helical winding 12. Successive turns of the second continuous single piece multi-turn helical winding 14 are interleaved between respective pairs of successive turns of the first continuous single piece multi-turn helical winding 12. The turns of the first and second continuous single piece multi-turn helical windings 12, 14 are spaced closely enough together to provide inductive coupling therebetween. Being wound instead of folded, the first and/or second continuous single piece multi-turn helical windings 12, 14 may have a continuous or smooth radius of curvature when projected on an X-Y plane (not shown) that is perpendicular to a longitudinal axis 16 (FIGS. 1, 3). In particular, the radius of curvature of the first and second continuous single piece multi-turn helical windings 12, 14 may have no discontinuities or singularities between a first terminal 12a, 14a, respectively, and a second terminal 12b, 14b, respectively.

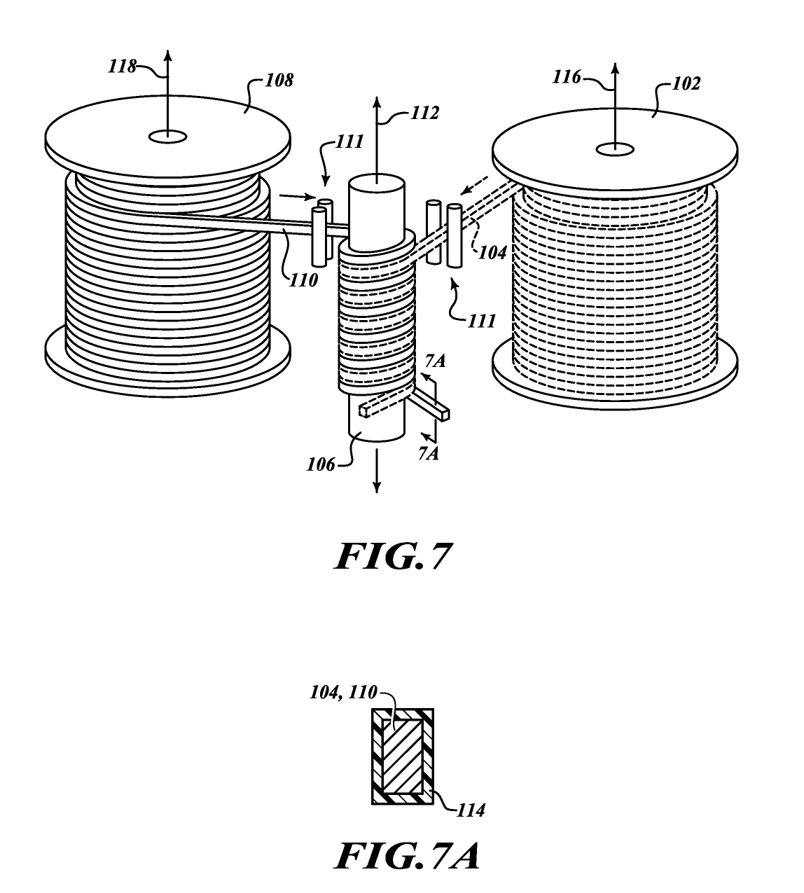

At least one of the first and/or the second continuous single piece multi-turn helical windings 12, 14 may be formed of a conductor such as a wire. The wire may advantageously have a rectangular cross section, best illustrated in FIG. 7A. The rectangular cross section may advantageously be relatively thick (i.e., thicker than either a heavy gauge foil or printed trace of conductive material). At least one of the first and/or the second continuous single piece multi-turn helical windings 12, 14 may have an electrically insulative sheath that at least partially surrounds the electrical conductor over at least some portion of a length of the first and/or second continuous single piece multi-turn helical windings 12, 14. In some embodiments, only one of the first or the second continuous single piece multi-turn helical windings 12, 14 carries the electrically insulative sheath, providing electrical insulation between that electrical conductor and the electrical conductor forming the other one of the continuous single piece multi-turn helical windings 12, 14. The electrically insulative sheet can be formed of any of a large variety of electrically insulative materials, for example various electrically insulative polymers (e.g., PTFE or TEFLON®, PVC, KAPTON®, rubber, polyethylene, or polypropylene).

The second continuous single piece multi-turn helical winding 14 may be coaxially aligned with the first continuous single piece multi-turn helical winding 12. The second continuous single piece multi-turn helical winding 14 may have an outer diameter OD₂ that may be equal to an outer diameter OD₁ of the first continuous single piece multi-turn helical winding 12. When coaxially aligned, the outer diameters OD₁, OD₂ of the first and second continuous single piece multi-turn helical windings 12, 14 may be coextensive. The second continuous single piece multi-turn helical winding 14 may have an inner diameter ID₂ that is equal to an inner diameter ID₁ of the first continuous single piece multi-turn helical winding 12. When coaxially aligned, the first and second continuous single piece multi-turn helical windings 12, 14 may have inner diameters ID₁, ID₂ that are coextensive. As illustrated in FIGS. 1-3, the first and the second continuous single piece multi-turn helical windings 12, 14 may be cylindrical, having a circular cross section. Other embodiments may employ other geometrical shapes, for example conic sections such as a cone, frustro-conical or hyperbola.

The first and second continuous single piece multi-turn helical windings 12, 14 may have only two terminals, one at each, 12a, 12b, 14a, 14b. The terminals 12a, 12b, 14a, 14b extend from respective ends of the first and second continuous single piece multi-turn helical windings 12, 14. The terminals 12a, 12b, 14a, 14b allow electrical connections to be made to respective circuits or portions of a circuit. Thus the transformer 10 may be easily integrated into various circuits.

FIG. 4 shows a transformer 20 according to another illustrated embodiment.

The transformer 20 includes a first continuous single piece multi-turn helical winding 22, and a second continuous single piece multi-turn helical winding 24. In this embodiment, each single turn of the second continuous single piece multi-turn helical winding is interleaved between a respective pair of turns of the first continuous single piece multi-turn helical winding. Thus, a ratio of turns of the first continuous single piece multi-turn helical winding 22 to turns of the second continuous single piece multi-turn helical winding 24 is close to 1:1, there being one more turn of the first continuous single piece multi-turn helical winding 22 than turns of the second continuous single piece multi-turn helical winding 24.

In some embodiments a primary continuous single piece multi-turn helical winding may have more turns than a secondary continuous single piece multi-turn helical winding. Alternatively, a secondary continuous single piece multi-turn helical winding may have more turns than a primary continuous single piece multi-turn helical winding. Transformers employ other ratios of turns than those illustrated in FIGS. 1-4 may be employed. For example, the a number of turns of the secondary winding may be wound before and/or after the turns of the primary winding are wound. Those initial or following secondary winding turns would not be interleaved with the turns of the primary winding, but some portion of the turns of the secondary winding would be interleaved with the turns of the primary winding. A ratio of turns of the first continuous single piece multi-turn helical winding 12 to turns of the second continuous single piece multi-turn helical winding 14 may, for example, be equal to or close to 1:1. The ratio of turns of the first continuous single piece multi-turn helical winding 12 to turns of the second continuous single piece multi-turn helical winding 14 may be greater than 1:1, for example 2:1, 3:1, 4:1 or more. The ratio of turns of the first continuous single piece multi-turn helical winding 12 to turns of the second continuous single piece multi-turn helical winding 14 may less than 1:1, for example 1:2, 1:3, 1:4 or less. Transformers may employ any other ratios of turns than those ratios generally described above

FIG. 5 shows a transformer 50 according to another illustrated embodiment.

The transformer 50 includes a first continuous single piece multi-turn helical winding 52, a second continuous single piece multi-turn helical winding 54, interleaved with the first continuous single piece multi-turn helical winding 52. The transformer 50 also includes a core 56 received through a passage formed by the inner diameters ID₁, ID₂ of the first and second continuous single piece multi-turn helical windings 52, 54, respectively. The core 56 may, for example, take the form of a magnetizable or ferrite material, for instance a rod or bar of ferrite, samarium cobalt or neodymium-iron-boron.

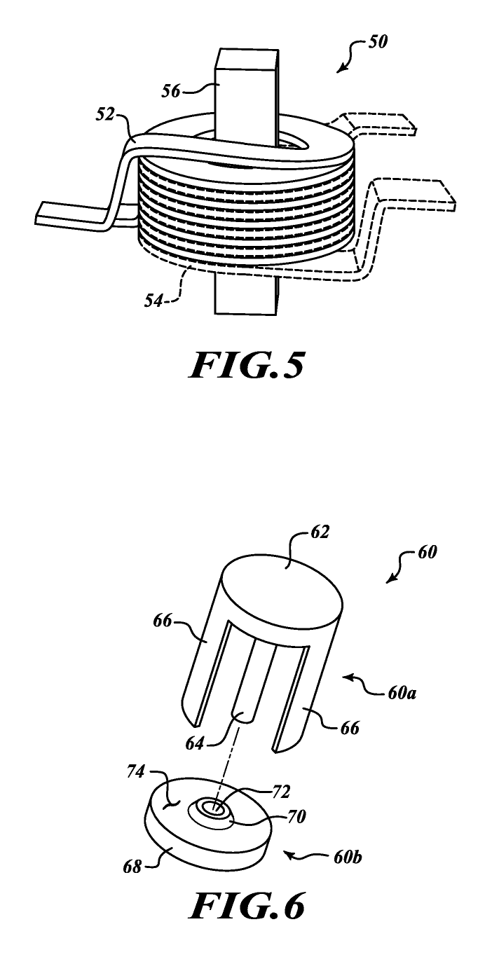

FIG. 6 shows a housing 60 suitable for use with a transformer having first and second continuous single piece multi-turn helical windings, according to one illustrated embodiment.

The housing 60 may include one or more parts, for example a first portion 60a and a second portion 60b.

The first portion 60a may include an end cover 60c and a core 60d, for example a magnetizable or ferrite core. The core 64 may be formed as a separate individual piece from the first and second parts 60a, 60b. Alternatively, the core 64 may be formed integrally as a single piece with either the first portion 60a or second portion 60b. Alternatively, a respective portion of the core 64 may be formed integrally with the first portion 60a or second portion 60b.

The first portion 60a may also include one or more arms 60e. The second portion 60b may include an end cap 68 which may have a post 70 that forms a recess 72 sized to receive a portion of the core 64. The end cap 68 may further form a recess 74 surrounding the post 70. The recess 74 may be sized and dimensioned to receive the arms 66 of the first portion 60a. The end cap 68 may securely receive the arms 66, for example, via a recess, ridge, tab, slot or other engagement structure to physically engage a complimentary recess, ridge, tab, slot or other engagement structure on the arm 66. The engagement may be realized through an interference fit. Employing a two or more portions 60a, 60b advantageously allows the multi-piece housing 60 to be installed after the first and second continuous single piece multi-turn helical windings are interleaved.

FIG. 7 shows a method of forming a transformer according to one illustrated embodiment.

A first supply reel 102 supplies a first electrical conductor 104 to a winding form or mandrel 106. The first electrical conductor 104 is wrapped about the winding form or mandrel 106 to form a first continuous single piece multi-turn helical winding. A second supply reel 108 supplies a second electrical conductor 110 to the winding form or mandrel 106. The second electrical conductor 110 is wrapped about the winding form or mandrel 106 to form a second continuous single piece multi-turn helical winding. The second electrical conductor 110 may be wrapped substantially concurrently with the wrapping of the first electrical conductor 104. While the winding form or mandrel 106 is shown as having a cylindrical shape, other shapes may be employed to achieve continuous single piece multi-turn helical windings of other configurations. The first and/or second electrical conductors 104, 108 may pass through one or more additional rollers or pairs of rollers, collectively 111 while advancing toward the winding form or mandrel 106. Such may be used to shape the electrical conductor(s) 104, 108, for example to facilitate the formation of the smooth radius of curvature. Additionally or alternatively, first and/or second electrical conductors 104, 108 may pass through one or more cutters (not shown) to separate the first and/or second continuous single piece multi-turn helical windings from the respective first and second supply reels 102, 108.

The second continuous single piece multi-turn helical winding is electrically isolated from the first continuous single piece multi-turn helical winding. For example, as best illustrated in FIG. 7A, one or both electrical conductors 104, 110 may include a sheath 114 of electrically insulative material. The second electrical conductor 110 may be wrapped such that successive turns of the second continuous single piece multi-turn helical winding are interleaved between pairs of successive turns of the first continuous single piece multi-turn helical windings. The turns are spaced sufficiently closely to one another to achieve inductive coupling therebetween.

In some embodiments, the winding form or mandrel 106 may be kept fixed while the first and second electrical conductors 104, 110 and/or supply reels 102, 108 are rotated thereabout. In other embodiments, the winding form or mandrel 106 may rotate about a longitudinal axis 112 while the supply reels 102, 108 rotate about respective axes 116, 118 to supply the electrical conductor 104, 110 to the winding form or mandrel 106. In other embodiments, the supply reels 102, 108 may rotate about the longitudinal axis 112 of the winding form or mandrel 106.

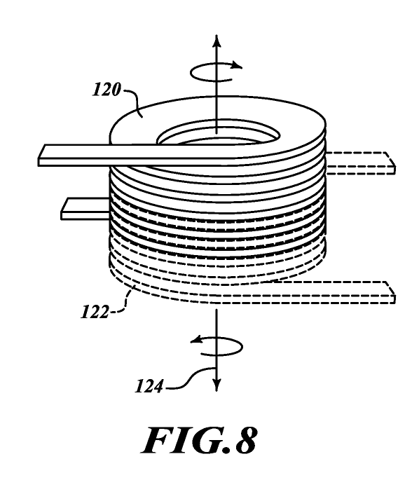

FIG. 8 shows a method of forming a transformer according to another illustrated embodiment.

A first electrical conductor 120 is wrapped to form a first continuous single piece multi-turn helical winding. A second electrical conductor is wrapped to form a second continuous single piece multi-turn helical winding 122. The first and the second electrical conductors 120, 122 may be wrapped to produce a smooth radius of curvature for the first and second continuous single piece multi-turn helical windings, respectively. One or more of the electrical conductors 120, 122 may include a sheath of electrically insulative material.

The second continuous single piece multi-turn helical winding may be advanced along a longitudinal axis 124 of the first continuous single piece multi-turn helical winding to position in which at least some of the turns of the second continuous single piece multi-turn helical winding are interleaved between at least some of the turns of the first continuous single piece multi-turn helical winding. The turns are spaced sufficiently closely to allow inductive coupling therebetween.

In some embodiments, the second continuous single piece multi-turn helical winding is advanced by rotating the second continuous single piece multi-turn helical winding about the longitudinal axis 124 with respect to the first continuous single piece multi-turn helical winding. As illustrated, the first and second continuous single piece multi-turn helical windings may have outer diameters OD₁, OD₂ that are equal and coextensive and inner diameters ID₁, ID₂ that are equal and coextensive.

As illustrated, the first and the second electrical conductors 120, 122 may advantageously have a rectangular cross section. The rectangular cross section may advantageously be relatively thick (i.e., thicker than either a heavy gauge foil or printed trace of conductive material).

As best illustrated in FIGS. 5 and 6, a core may be inserted within the inner diameter ID₁, ID₂ formed by the first and the second continuous single piece multi-turn helical windings. The core may, for example, advantageously comprise a magnetizable or ferrous material.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other transformers, not necessarily the exemplary transformers generally described above.

The various embodiments described above can be combined to provide further embodiments. To the extent that they are not inconsistent with the specific teachings and definitions herein, U.S. patent applications Ser. No. ______, entitled “Transformer With Concentric Windings and Method of Manufacture of Same” and filed concurrently herewith (Atty. Docket No. 480127.405) are incorporated herein by reference, in its entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A transformer, comprising:
a first continuous single piece multi-turn helical winding having a continuous smooth radius of curvature with no discontinuities between a first terminal and a second terminal as projected on an X-Y plane that is perpendicular to a longitudinal axis of the first continuous single piece multi-turn helical winding; and
a second continuous single piece multi-turn helical winding having a continuous radius of curvature with no discontinuities between a first terminal and a second terminal as projected on an X-Y plane that is perpendicular to a longitudinal axis of the second continuous single piece multi-turn helical winding, the second continuous single piece multi-turn helical winding electrically insulated from the first continuous single piece multi-turn helical winding and having at least some of a plurality of successive turns of the second continuous single piece multi-turn helical winding interleaved between respective pairs of at least some of a plurality of successive turns of the first continuous single piece multi-turn helical winding to inductively couple therebetween.

2. The transformer of claim 1 wherein at least one of the first or the second continuous single piece multi-turn helical windings comprises a conductor having a rectangular cross-section taken perpendicular to a longitudinal axis of the first or the second continuous single piece multi-turn helical windings at a point along the longitudinal axis.

3. The transformer of claim 1 wherein at least one of the first or the second continuous single piece multi-turn helical windings comprises an electrical conductor having an electrically insulating sheath thereabout.

4. The transformer of claim 1 wherein the second continuous single piece multi-turn helical winding is co-axially aligned with the first continuous single piece multi-turn helical winding.

5. The transformer of claim 4 wherein the second continuous single piece multi-turn helical winding has an outer diameter that is equal to an outer diameter of the continuous single piece multi-turn helical winding.

6. The transformer of claim 4 wherein the second continuous single piece multi-turn helical winding has an inner diameter that is equal to an inner diameter of the first continuous single piece multi-turn helical winding.

7. The transformer of claim 1 wherein at least one of the first or the second continuous single piece multi-turn helical windings is cylindrical.

8. The transformer of claim 1 wherein the first continuous single piece multi-turn helical winding has only two terminals, each of the two terminals extending from a respective end of the first continuous single piece multi-turn helical winding and wherein the second continuous single piece multi-turn helical winding has only two terminals, each of the two terminals extending from a respective end of the second continuous single piece multi-turn helical winding.

9. The transformer of claim 1, further comprising:
at least a portion of a ferromagnetic core received within an inner diameter of at least one of the first or the second continuous single piece multi-turn helical windings.

10. A method of forming a transformer, the method comprising:
wrapping a first electrical conductor about a winding form to form a first continuous single piece multi-turn helical winding; and
wrapping a second electrical conductor about the winding form to form a second continuous single piece multi-turn helical winding, the second continuous single piece multi-turn helical winding electrically insulated from the first continuous single piece multi-turn helical winding, with at least some of a number of successive turns of the second continuous single piece multi-turn helical winding interleaved between pairs of at least some of a number of successive turns of the first continuous single piece multi-turn helical windings to inductively couple therebetween.

11. The method of claim 10 wherein wrapping the second electrical conductor about the form is performed substantially concurrently with wrapping the first electrical conductor about the form.

12. The method of claim 10 wherein wrapping a first electrical conductor about a winding form includes wrapping the first electrical conductor having a rectangular cross-section about the winding form to produce a smooth radius of curvature between a first terminal and a second terminal of the first multi-turn helical winding.

13. The method of claim 10 wherein wrapping at least one of the first or the second electrical conductors about the winding form includes wrapping a sheathed electrical wire about the winding form.

14. The method of claim 10, further comprising:
inserting at least a portion of a ferromagnetic core within an inner diameter formed by the first and the second continuous single piece multi-turn helical windings.

15. A method of forming a transformer, the method comprising:
wrapping a first electrical conductor to form a first continuous single piece multi-turn helical winding;
wrapping a second electrical conductor to form a second continuous single piece multi-turn helical winding; and
advancing the second continuous single piece multi-turn helical winding along a longitudinal axis of the first continuous single piece multi-turn helical winding to position at least some of the turns of the second continuous single piece multi-turn helical winding interleaved between at least some of the turns of the first continuous single piece multi-turn helical winding to inductively couple therebetween.

16. The method of claim 15 wherein advancing the second continuous single piece multi-turn helical winding along a longitudinal axis of the first continuous single piece multi-turn helical winding includes rotating the second continuous single piece multi-turn helical winding about the longitudinal axis with respect to the first continuous single piece multi-turn helical winding.

17. The method of claim 15 wherein wrapping a second electrical conductor to form a second continuous single piece multi-turn helical winding includes wrapping the second electrical conductor to form the second continuous single piece multi-turn helical winding to have an outer diameter equal to an outer diameter of the first continuous single piece multi-turn helical winding.

18. The method of claim 15 wherein wrapping a second electrical conductor to form a second continuous single piece multi-turn helical winding includes wrapping the second electrical conductor to form the second continuous single piece multi-turn helical winding to have an inner diameter equal to an inner diameter of the first continuous single piece multi-turn helical winding.

19. The method of claim 15 wherein wrapping a first electrical conductor to form a first continuous single piece multi-turn helical winding includes wrapping the first electrical conductor having a rectangular cross-section to produce a smooth radius of curvature of the first continuous single piece multi-turn helical winding and wherein wrapping a second electrical conductor to form a second continuous single piece multi-turn helical winding includes wrapping the second electrical conductor having a rectangular cross-section to produce a smooth radius of curvature of the second continuous single piece multi-turn helical winding.

20. The method of claim 15 wherein wrapping at least one of the first or the second electrical conductors includes wrapping a sheathed electrical conductor having an electrically insulating sheath thereabout.

21. The method of claim 15, further comprising:
inserting at least a portion of a ferromagnetic core within an inner diameter formed by the first and the second continuous single piece multi-turn helical windings.
